(19) United States
(12) Patent Application Publication
(10) Pub. No.: US 2018/0354618 A1
(43) Pub. Date: Dec. 13, 2018

(54) ACTIVE TETHERS FOR CONTROLLING UAV FLIGHT VOLUMES, AND ASSOCIATED METHODS AND SYSTEMS

(71) Applicant: PreNav, Inc., Redwood City, CA (US)

(72) Inventors: Nathan Schuett, Belmont, CA (US); Asa Hammond, Cotati, CA (US)

(21) Appl. No.: 16/006,479

(22) Filed: Jun. 12, 2018

Related U.S. Application Data
(60) Provisional application No. 62/519,089, filed on Jun. 13, 2017.

(51) Int. Cl. B64C 39/02; B64D 17/80; G05D 1/10; G05D 1/00

(52) U.S. Cl. CPC B64C 39/022; B64C 39/024; B64C 2201/148; G05D 1/101; G05D 1/0055; B64D 17/80

(57) ABSTRACT

Active tethers for controlling UAV flight volumes, and associated methods and systems, are disclosed. A method in accordance with a representative embodiment includes directing a UAV upwardly from a launch site, receiving an indication of a UAV failure or upcoming failure while the UAV is aloft, and in response to the indication, applying an acceleration to the UAV via a tether attached to the UAV.

### CROSS-REFERENCE TO RELATED APPLICATION

The present application claims priority to pending U.S. Provisional Application No. 62/519,089, filed Jun. 13, 2017 and incorporated herein by reference.

### TECHNICAL FIELD

The present technology is directed generally to active tethers for controlling flight volumes in which UAVs operate, and associated systems and methods, including further restraints.

### BACKGROUND

Unmanned aerial vehicles (UAVs) have become increasingly popular devices for carrying out a wide variety of tasks that would otherwise be performed by manned aircraft or satellites. Such tasks include surveillance tasks, imaging tasks, and payload delivery tasks. However, UAVs have a number of drawbacks. For example, it can be difficult to operate UAVs, particularly autonomously, in close quarters, e.g., near buildings, trees, or other objects. In particular, it can be difficult to prevent the UAVs from colliding with such objects. Accordingly, UAVs may be unable to perform the desired surveillance tasks in areas where potential hazards are located nearby. Therefore, there remains a need for techniques and associated systems that can allow UAVs to safely and accurately navigate within working environments that may include regions where the UAV is to be excluded.

### BRIEF DESCRIPTION OF THE DRAWINGS

FIG. 1 is a partially schematic illustration of a UAV operating with a tether in accordance with some embodiments of the present technology.

FIG. 2 is a partially schematic illustration of a UAV operating from an elevated position using a tether in accordance with some embodiments of the present technology.

FIG. 3 is a partially schematic illustration of a UAV gathering information to increase the volume of the region in which the UAV operates.

FIG. 4 is a partially schematic illustration of a UAV operating with a tether and belay device in accordance with some embodiments of the present technology.

FIG. 5 is a flow diagram illustrating a representative method for operating UAVs in accordance with some embodiments of the present technology.

FIG. 6 is another flow diagram illustrating representative methods for operating UAVs in accordance with some embodiments of the present technology.

### DETAILED DESCRIPTION

The present technology is directed generally to systems and methods for restraining the flight of a UAV, e.g., via a tether. For example, in some embodiments, the tether is connected to a winch that automatically responds to an indication of a UAV failure, or potential failure, by rapidly reeling in the UAV. In some embodiments, the winch can reel in the UAV faster than the un-augmented descent rate of the UAV, even if the UAV has failed and is falling to the ground. This arrangement can allow the UAV to fly in a larger flight volume, even if hazards or other features to be avoided exist within that flight volume. For example, the ability to rapidly reel in the UAV in the case of a failure can significantly mitigate the likelihood that the UAV will strike a hazard, even if it fails above and/or beyond the hazard. In some embodiments, other techniques can be used in addition to, or in lieu of, the rapidly operating winch. For example, the tether can pass through one or more belay devices that allow the UAV to operate in potentially exposed environments with only a limited range over which the UAV may travel if it fails. In another example, a parachute can be deployed in combination with an actively operating winch, with the parachute slowing the UAVs rate of descent, which can help to limit the potential crash radius further and preserve the aircraft.

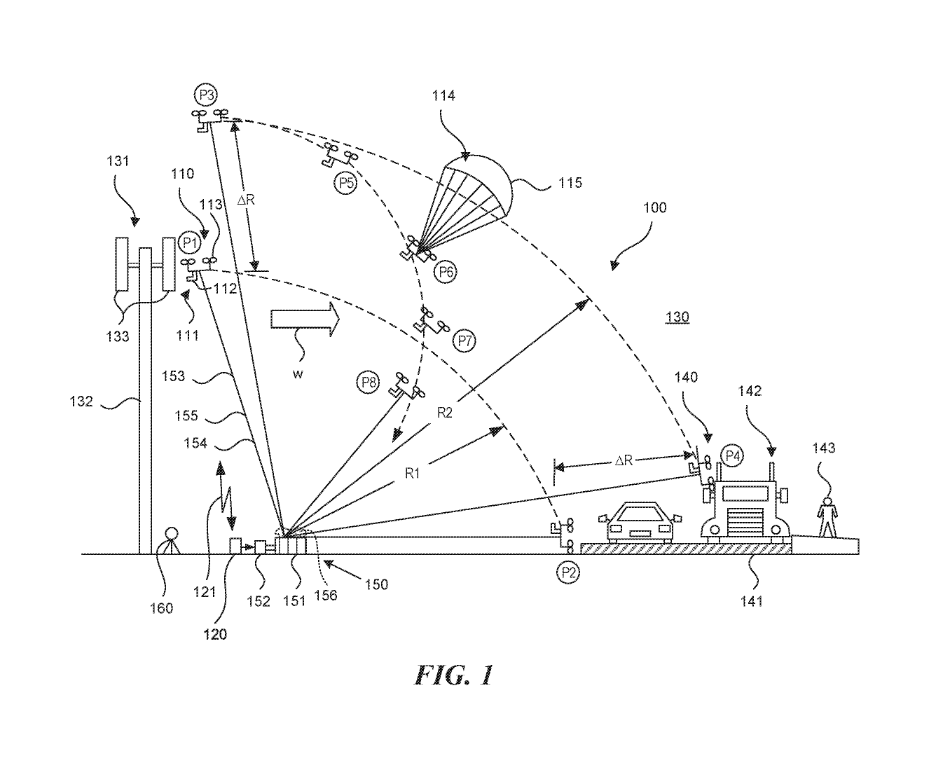

Specific details of some embodiments of the disclosed technology are described below with reference to particular, representative configurations. The disclosed technology may be practiced in accordance with UAVs and associated systems having other configurations. And in some embodiments, particular aspects of the disclosed technology may be practiced in the context of autonomous vehicles other than UAVs (e.g., autonomous land vehicles or watercraft). Specific details describing structures or processes that are well-known and often associated with UAVs, but that may unnecessarily obscure some significant aspects of the presently disclosed technology, are not set forth in the following description for purposes of clarity. Moreover, although the following disclosure sets forth some embodiments of different aspects of the disclosed technology, some embodiments of the technology can have configurations and/or components different than those described in this section. As such, the present technology may have some embodiments with additional elements and/or without several of the elements described below with reference to FIGS. 1-6.

Several embodiments of the disclosed technology may take the form of computer-executable instructions, including routines executed by a programmable computer or controller. Those skilled in the relevant art will appreciate that the technology can be practiced on computer or controller systems other than those shown and described below. The technology can be embodied in a special-purpose computer, controller, or data processor that is specifically programmed, configured, or constructed to perform one or more of the computer-executable instructions described below. Accordingly, the terms “computer” and “controller” as generally used herein include a suitable data processor (airborne and/or ground-based) and can include internet appliances and hand-held devices, including palm-top computers, wearable computers, cellular or mobile phones, multi-processor systems, processor-based wire programmable consumer electronics, network computers, laptop computers, mini-computers, and the like. Information handled by these computers can be presented at any suitable display medium, including a liquid crystal display (LCD). As is known in the art, these computers and controllers commonly have various processors, memories (e.g., non-transitory computer-readable media), input/output devices, and/or other suitable features.

The present technology can also be practiced in distributed environments, where tasks or modules are performed by remote processing devices that are linked through a communications network. In a distributed computing environment, program modules or subroutines may be located in local and remote memory storage devices. Aspects of the technology described below may be stored or distributed on computer-readable media, including magnetic or optically readable or removable computer disks, as well as distributed electronically over networks. Data structures and transmissions of data particular to aspects of the technology are also encompassed within the scope of the present technology.

FIG. 1 is a partially schematic illustration of a system 100 that includes a UAV 110 operating in an environment 130. The environment 130 can include a target 131 (e.g., a surveillance target for the UAV 110), and one or more hazards 140 or other objects or features to be avoided (e.g., vehicles 142 and pedestrians 143 at a roadway 141). The overall system 100 can include a restraint system 150 configured to allow the UAV 110 to perform its mission at the target 131, while significantly mitigating the risk that a failure of the UAV 110 will cause it to collide or otherwise interfere with the hazard 140.

The UAV 110 can include a payload 111 (e.g., one or more cameras or other sensors 112 used to assess the target 131). The UAV 110 can further include a propulsion system 113 that moves it into position relative to the target 131. In some embodiments, the target 131 can include a tower 132 carrying cellular network antennas 133, or other structures that benefit from an inspection, servicing, and/or other operation performed by the UAV 110.

The restraint system 150 can include a tether 153 connected between the UAV 110 and a winch 151. The tether 153 can include a restraint line 154 that is robust enough to restrict the motion of the UAV 110 and accelerate the UAV 110 toward the winch 151, as will be described in further detail later. The tether 153 can also include a communication line 155 that provides a hardwired link between the UAV 110 and a controller 120. The controller 120 can also communicate with the UAV via wireless link 121. In addition, the controller 120 can be coupled to a winch motor 152 that drives the winch 151, so as to control the operation of the winch 151.

In one mode of operation, the restraint system 150 is configured to allow the UAV 110 to fly at a first maximum distance or radius R1 from the winch 151. The first radius R1 is sufficient to allow the UAV 110 to perform at least some aspects of its surveillance mission from a first position P1. The first radius R1 is selected so that if the UAV 110 fails at any point within the hemispherical volume described by the first radius R1 and is forced to the ground, the UAV 110 will not strike the hazard 140. For example, if the UAV 110 is carried toward the hazard 140 by a strong wind W or by a propulsion or navigation system failure, the limited first radius R1 will prevent the UAV 110 from impacting the hazard 140, even at the closest position (P2) to the hazard 140.

In the first operation mode described above, the UAV 110 flies its mission while the winch 151, under the direction of the controller 120, controls the tension on the tether 153. Accordingly, if the UAV 110 is deliberately directed away from the winch 151, the controller 120 can direct the winch motor 152 to allow slack in the tether 153, up to the first radius R1. If the UAV 110 flies toward the winch 151, the controller 120 can direct the winch motor 152 to take up the resulting slack. In either case, the flight path of the UAV 110 is not controlled by the tether 153, except to the extent that the maximum paid-out length of the tether 153 limits the maximum distance (R1) the UAV 110 can travel.

In a second mode of operation, the restraint system 150 can be configured to actively control the motion of the UAV 110 (once the active restraint function is activated), for example in case of an emergency. In this mode, the UAV 110 can travel a further distance away from the winch 151 (as indicated by a second radius R2). Accordingly, the UAV 110 can increase its travel radius by AR compared to the first radius R1. This in turn allows the UAV 110 to travel to a third position P3 that allows it greater access to the target 131. The larger second radius R2 also allows the UAV 110 to fly over the hazard 140. To offset or eliminate the risk of a UAV failure causing a collision with (or otherwise interfering with) the hazard 140, the system 100 includes provisions for actively accelerating and/or otherwise redirecting the UAV 110 away from the hazard 140. For example, if the UAV 110 were to fail at the third position P3 and travel toward the hazard 140 along the second radius R2, it would impact the hazard 140, as indicated by a fourth position P4. In the second mode of operation, however, the controller 120 receives an input (e.g., from the UAV 110), indicating a failure (e.g., an actual failure, or an incipient failure, or an upcoming failure, or an expected or predicted failure), and responds by directing the winch motor 152 and winch 151 to rapidly reel in the tether 153. Depending on the particular arrangement, the input received by the controller 120 can be a fully automated input (e.g., the controller 120 receives an automatically-generated input from a sensor onboard or offboard the UAV 110), or the input can include a manual element (e.g., the controller 120 receives an input from a user manually operating a switch). In either case, the ensuing response initiated by the controller 120 redirects the UAV 110 toward the winch 151 along a descent line or path that is more circumscribed than a circular arc with a radius of R2 (which would intersect the hazard 140), as indicated by descent positions P5, P6, P7 and P8. This circumscribed path can prevent the UAV 110 from contacting the ground any closer to the hazard 140 than the second position P2. In some embodiments, the rapid action of the winch 151 can cause the UAV 110 to strike the ground at any point short of the hazard 140, up to the winch 151.

To achieve the foregoing effect, the winch 151 can be driven at an acceleration and speed that not only keeps up with the slack in the tether 153 (e.g., as the UAV 110 descends due to a failure), but that places enough tension on the tether 153 to accelerate the UAV 110 toward the winch 151. For example, the winch 151 can put sufficient tension on the UAV 110 to accelerate it downwardly to a speed greater than the speed with which the UAV 110 would fall in an uninhibited manner as a result of a failure.

The UAV 110 may encounter any of a variety of possible failures that trigger a retraction response by the controller 120 and winch 151. For example, the failure may occur at one or more of the propellers, motors, electronic speed controllers, batteries, navigation units, and/or communication units carried by the UAV 110. A failure can be detected in any of a variety of suitable manners. For example, if a motor or a propeller fails, a suitable sensor can be used to detect an uncommanded motor speed change. A voltage sensor can detect a battery failure, and other sensors or algorithms can detect a failure in the UAV navigation and/or communication systems. In response to the indicated failure, the UAV 110 can send a signal via the wired communication line 155 or the wireless link 121, which is received by the controller 120 and which results in the accelerated winch 151 action described above. In other cases, for example, the UAV 110 may begin traveling in a direction not authorized by either a manual operator or by an autonomous flight plan. In such cases, the failure corresponds to a specific location of the UAV 110 (e.g., an unauthorized location), which can be detected via GPS, or a ground-based scanner 160, or another suitable device. In any of these instances, a corresponding signal is sent to the controller 120, which directs the winch 151.

While the winch motor 152 and the winch 151 are configured to rapidly accelerate the UAV 110 toward the winch 151 in the case of a failure, such acceleration may not be rapid enough to avoid a collision with the hazard at all points within the hemispherical volume described by the second radius R2. For example, if the UAV 110 flies autonomously or under operator control to the fourth position P4 and then fails (the fourth position P4 now representing a failure point), the winch 151 may not be able to pull the UAV 110 out of harm's way before it strikes a vehicle 142 or other element of the hazard 140. Accordingly, the volume within which the UAV 110 is permitted to operate may have a more complex shape than a simple hemisphere. For example, the authorized flight volume can have a decreasing radius near the hazard 140. The controller 120 can therefore include or have access to the more complexly shaped flight volume, and/or can include an algorithm for determining the shape of the flight volume.

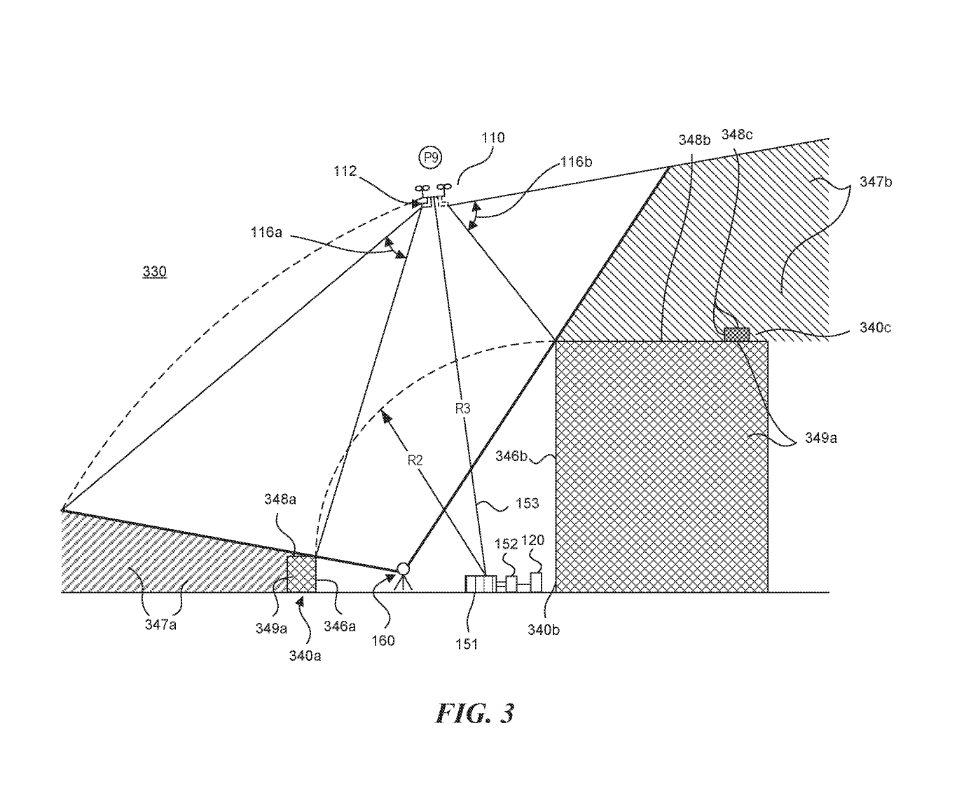

To help define the flight volume within which the UAV 110 is authorized to operate, the scanner 160 can be used to scan the environment 130 and identify hazards. Once the hazards are identified, the system 100 can automatically identify how the flight volume should change to account for the hazard(s), by weighting factors such as the maximum descent rate of the UAV 110 in case of a failure, and the maximum acceleration and velocity imparted to the tether 153 in response to a failure indication. As will be described later with reference to FIG. 3, the UAV 110 itself can be used to expand on the information provided by the scanner 160.

In at least some embodiments, the UAV 110 can include a speed brake 114 to slow its descent in case of a failure and thus allow more time for the winch 151 to reel it in, which in turn enables more control over the final landing position of the UAV. For example, the speed brake 114 can include a parachute 115 (and/or another suitable device), which slows the descent rate of the UAV 110 and provides more time for the winch 151 to draw the UAV 110 inwardly away from the hazard 140. In one embodiment, the winch motor 152 can effectively reel in the UAV 110 so that it reliably comes to rest in a safe landing zone 156 directly above the winch 151 (due to the slowed descent caused by the speed brake 114).

In at least some embodiments, the safe landing zone 156 can be outfitted with protective padding, netting, or another suitable material to soften the landing of the UAV 110. In some cases, the speed at which the winch 151 draws in the UAV 110 with activated speed brake 114 may preserve the integrity of the aircraft. In other cases, the speed with which the winch 151 draws in the UAV 110 may exceed the speed rating of the speed brake 114 or the safe landing zone 156. In such embodiments, the speed brake 114 can be jettisoned, or can simply be allowed to fail as the UAV 110 is drawn inwardly and away from the hazard 140. In some embodiments, the UAV 110 and/or the safe landing zone 156 may be destroyed to ensure the hazard 140 is not impacted.

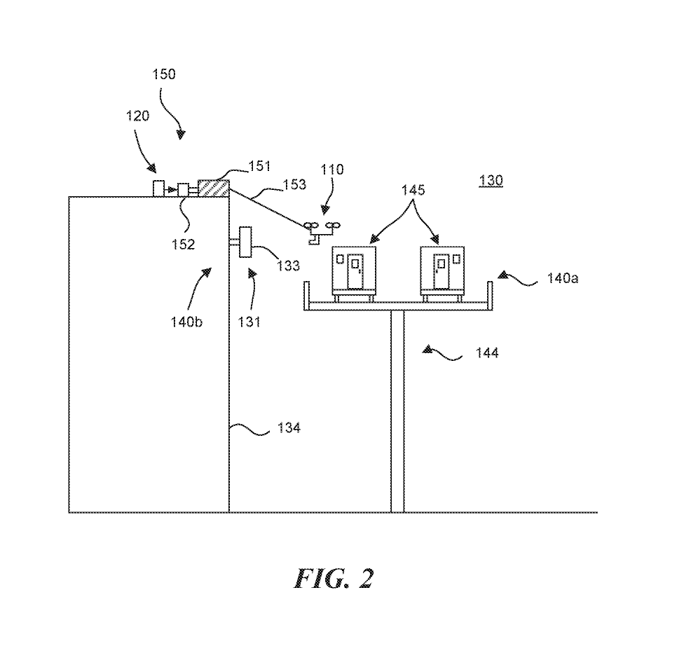

In some embodiments described above, the UAV 110 is positioned above the winch 151 to carry out its mission. In other embodiments, for example, as illustrated in FIG. 2, the winch 151 can be positioned above the UAV 110. For example, the target 131 can include an antenna 133 extending from a building 134, and the winch 151 can be positioned on the roof of the building 134. The constrained environment 130 shown in FIG. 2 can include a first hazard 140a, for example an elevated train line 144 carrying trains 145. The flight envelope for the UAV 110 can be constrained but can still allow the UAV 110 to overfly the hazard 140a, e.g., to provide a vantage point from which to assess the target 131, provided the maximum acceleration and speed of the winch 151 allow the UAV 110 to be diverted away from the first hazard 140a. A second “hazard” 140b can include the target 131 itself, If the UAV 110 were to fail at some point along a proposed flight envelope or volume, it might swing into the antenna 133. Accordingly, the flight envelope can be tailored, taking into account the maximum speed of the winch 151, to allow the UAV 110 to fly close to the antenna 133, while preserving the ability to quickly pull the UAV 110 upwardly and away from the antenna 133 in case of a failure.

FIG. 3 is a partially schematic illustration of the UAV 110 operating in another environment 330. The environment 330 can include a first hazard 340a (e.g., a sensitive structure) and a second hazard 340b (e.g., a building). The scanner 160 is used to map out a permissible flight volume indicated by the second radius R2. As discussed above, the second radius R2 may have different values at various points within the volume. For example, the second radius R2 may have a greater value near the second hazard 340b than near the first hazard 340a.

As part of the process for mapping the environment 330, the scanner 160 can identify known hazard surfaces, for example a first known hazard surface 346a at the first hazard 340a and a second known hazard surface 346b at the second hazard 340b. Because the sensor 160 may not be able to sense the environment behind the hazard surfaces 346a, 346b, the environment 330 includes corresponding unknown regions 347a, 347b. Without further information, the permissible or authorized flight envelope or volume will typically exclude the unknown regions 347a, 347b to avoid risk. However, in some embodiments, the UAV 110 itself can be used to reduce the extent of the unknown regions 347a, 347b, thus increasing the available flight envelope for the UAV 110. For example, the UAV 110 can be flown to an extended radius R3, under the control of the tether 153. Once aloft at a ninth position P9, the UAV 110 can orient the on-board camera 112 or other sensor to have fields of view that include portions of the unknown regions 347a, 347b. For example, the camera 112 can have a first field of view 116a that includes at least a portion of the first unknown region 347a, and a second field of view 116b that includes at least a portion of the second unknown region 347b. As a result of the additional information gained from the UAV 110 via the first and second fields of view 116a and 116b, the flight envelope can be updated to include a first updated hazard surface 348a and corresponding first updated hazard region 349a, as well as a second updated hazard surface 348b and corresponding updated hazard region 349a. The UAV 110 can, in the illustrated embodiment, identify a third hazard 340c, with corresponding third updated hazard surfaces 348c. Aside from the updated hazard surfaces 348, the remaining portions of the initially unknown regions 347a, 347b are now known, and the flight envelope can accordingly be extended into these regions, with the tether 153 operating to retract the UAV 110 from these regions in case of a UAV failure.

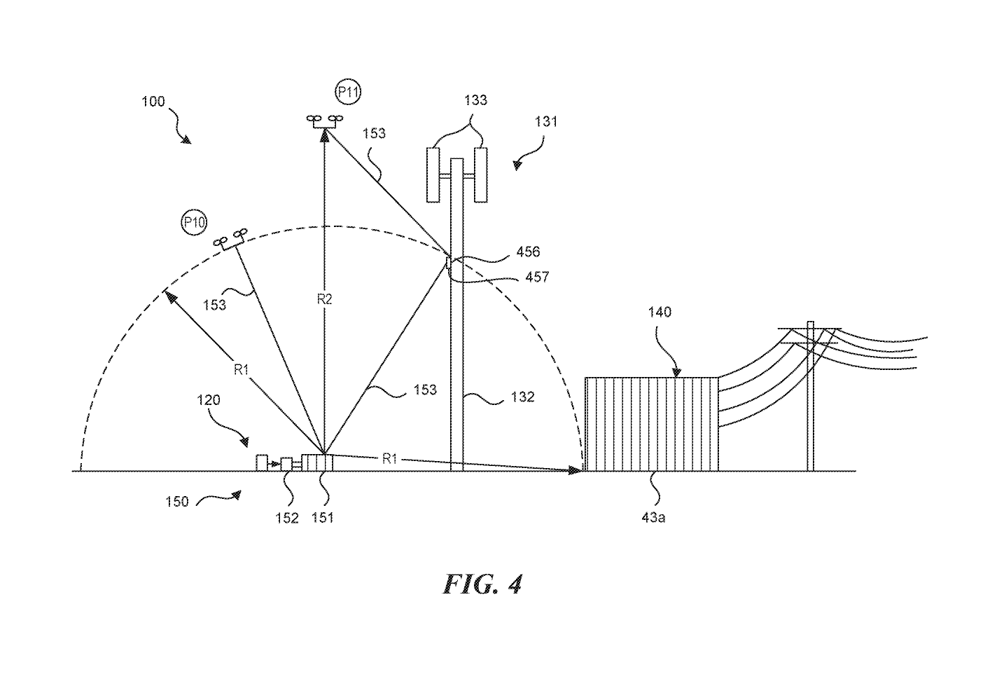

FIG. 4 is a partially schematic illustration of a restraint system 150 that operates in accordance with some embodiments of the present technology. The restraint system 150 can include a winch 151, winch motor 152, tether 153, and controller 120 that operate in a manner generally similar to that described above with reference to FIGS. 1-3. In a first mode of operation, the tether 153 can have a first radius R1 that allows the UAV 110 to operate without the need for an accelerated reel-back operation to avoid a corresponding hazard 140 (in this example, a power substation 439). Accordingly, the UAV 110 can ascend to a tenth position P10 along the first radius R1. In a second mode of operation, the tether 153 extends to a second radius R2, which means the UAV 110 can fly over the hazard 140, with the winch 151 operable in the manner described above to prevent contact between the UAV 110 and the hazard 140 in the event of a UAV failure.

In a third mode of operation, the tether 153 can pass through a belay device 457 positioned at a belay point 456 to further restrain the motion of the UAV 110 in the event of a failure. In particular, if the UAV 110 fails while at an eleventh position P11, its motion is constrained by the belay device 457 to prevent contact with the hazard 140. Instead, the UAV 110 can remain suspended from the belay point 456 by the tether 153. The belay device 457 can suspend the UAV 110, whether or not the winch 151 is also operated in an accelerated manner. Accordingly, the belay device 457 can be used either alone or in conjunction with the accelerated reel operation described above.

In a particular embodiment, the target 131 to which the UAV is directed includes a tower 132 carrying one or more antennae 133, and the belay point 456 can be located at the tower 132. In other embodiments, the belay point 456 can have other locations. In some embodiments, the belay device 457 can be placed in position by a human operator, or by the UAV 110. For example, the belay device 457 can have an electromagnetic actuator that attaches it to the tower 132. After use, the electromagnet can be remotely deactivated so that the belay device 457 can be returned to the ground for later use. Another electromagnet can be coupled to a gate of the belay device 457 to selectively engage with and disengage from the tether 153. In other embodiments, the belay device 457 can be permanently fixed in the environment and available for attachment. In yet another embodiment, the belay point 456 can be created by the UAV 110 without the need for a belay device 457. For example, the UAV 110 can fly several times around the tower 132, wrapping the tether 153 tightly around the belay point 456.

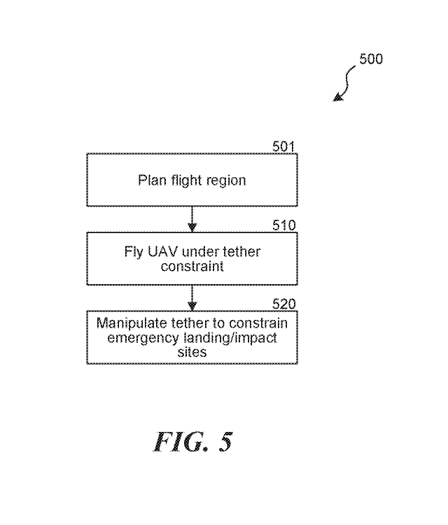

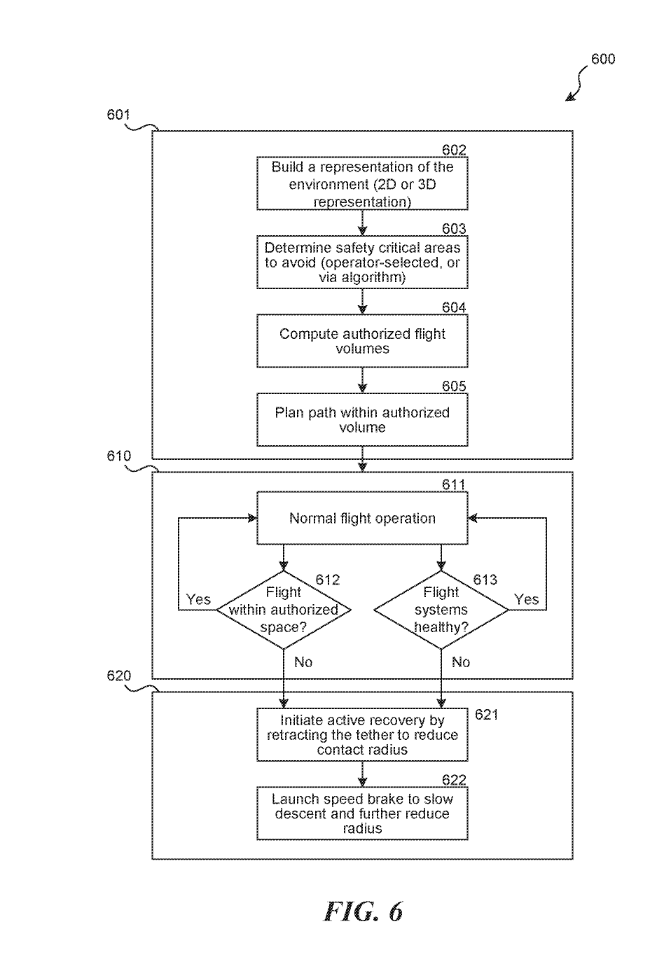

As discussed above, systems configured in accordance with the present technology can be operated in a variety of suitable manners to limit or constrain the regions in which a UAV 110 flies, so as to reduce or minimize the risk of a collision between the UAV 110 and objects in its environment 130, in the event of a UAV failure. As shown in FIG. 5, a representative method 500 includes planning or identifying a flight region (block 501), flying a UAV under tethered (and/or other) constraint within the flight region (block 510) and manipulating the tether to constrain emergency landing or impact sites (block 520). Any of the foregoing tasks can be performed independently of the others, and/or can include one or more subprocesses, as described below with reference to FIG. 6.

FIG. 6 illustrates specific details of several of the processes or steps described above with reference to FIG. 5, suitable for some embodiments of the present technology. Generally, a representative process 600 includes a planning phase (block 601), a flight stage (block 610) and a termination phase (block 620). Each of the foregoing phases can include one or more associated steps or processes. For example, the planning phase 601 can include building a representation of the environment within which the UAV operates. The representation can have a number of suitable configurations, including a two-dimensional representation or a three-dimensional representation. The representation can be obtained from the scanner 160 described above with reference to FIGS. 1 and 3, alone or with additional inputs. For example, Google Maps or another preexisting database can be used as an initial representation, and can be updated, as necessary, with data obtained more recently via the scanner 160 or other suitable device.

At block 603, the process includes determining or identifying specific areas for the UAV 110 to avoid (e.g., hazards). Such areas may be safety-critical and/or have other reasons for being restricted. In some embodiments, such areas are selected by the operator (e.g., using a 2-D map or a 3-D representation), and in some embodiments the areas can be automatically determined, for example by using appropriate optical recognition techniques, databases, and/or other techniques. The areas can be generally flat (e.g., roads) or can have more 3-D shapes (e.g., buildings).

Based on the initial representation of the environment and the specified areas to be avoided, the process can further include determining authorized flight volumes (block 604). This process can include combining an initial unrestricted volume with volumes that have been identified as safety-critical or otherwise sensitive. To determine the extent of the ultimately restricted areas, the process can include accounting for where the winch is located, which in turn determines the envelope of suitable tether orientations and radii. The orientation and radius of the tether can in turn determine the time required to withdraw the UAV in the case of a failure. Other factors include, but are not limited to, the proximity of the restricted areas to safe landing areas, the length of the tether at various elevations or altitudes, the tether retraction rate, the weight of the UAV, wind speeds, whether or not a speed brake is used and, if used, at what rate the speed brake deploys. The result can include a volume within which the UAV is expected to fly safely, and within which the UAV can avoid hazards, even in the case of a UAV failure.

Block 605 includes planning a flight path within the authorized flight volume established above. In some embodiments, the user can create the flight path, with constraints provided by the system. In other embodiments, an algorithm can build the flight path, also taking into account the constraints. In still further embodiments, block 605 can be eliminated and the operator can fly without a flight plan while in the authorized flight volume. To prevent incidental or accidental contact with hazards, and/or flying into unsafe areas, the system can automatically constrain the flight of the UAV, via the tether, to avoid such areas.

Block 610 (flying the UAV) can include normal flight operations (block 611). As part of the normal flight operations, the system can repeatedly check one or more safety indications. For example, at block 612, the system can determine whether the UAV is within the authorized flight volume (e.g., a safe-state space) defined above. This process can include checking the position, velocity, and/or acceleration of the UAV in accordance with a preset schedule (e.g., multiple times per second). If it is, the loop continues to iterate. If not, the process passes to the termination phase 620. In addition to (e.g., in parallel with) determining whether the system is operating hi the authorized flight volume, the process can include determining whether the flight systems are healthy (block 613). Representative systems include sensors, actuators, and/or estimators. If so, the loop reiterates, and if not, the process proceeds to the termination phase 620.

The termination phase 620 can include initiating active recovery by retracting the tether to reduce the flight radius available to the UAV and thereby prevent the UAV from contacting hazards or unsafe areas (block 621). For example, as discussed above, in response to an indication of a failure or imminent failure, the system can immediately accelerate the UAV, via the tether, toward the winch. In some embodiments, the system can attempt to limit damage to the UAV, for example by repeatedly attempting to restart the UAV or otherwise reduce the impact force of the UAV. In any of the foregoing embodiments, it is generally expected that damage to the UAV, while undesirable, is less undesirable than damage to the hazard that the UAV is being kept away from. Accordingly, in a typical operation, priority is given to extracting the UAV from what would otherwise be close proximity to a hazard. Optionally, the process can include deploying a speed brake (e.g., a parachute) to show the UAV descent rate and further reduce the contact radius (block 622).

One feature of some of the embodiments described above is that the tether can allow a UAV to fly within regions from which it would otherwise be excluded. In particular, the tether can be coupled to a winch that responds quickly enough, and accelerates the tether quickly enough, to remove the UAV from a potentially hazardous area, in the event of a failure of the UAV, before the UAV contacts sensitive structures and/or otherwise interferes with devices or people in the hazardous area. Accordingly, such embodiments can improve the working range of the UAV without unnecessarily increasing associated risks.

### ADDITIONAL EXAMPLES

Several aspects of the present technology are set forth in the following examples.

1. A method for operating a UAV, comprising:
receiving an indication of a UAV failure or predicted failure while the UAV is aloft; and
in response to the indication, applying an acceleration to the UAV via a tether attached to the UAV.

2. The method of example 1 or example 2, further comprising:
directing the UAV upwardly from a launch site prior to receiving the indication.

3. The method of any of examples 1-3, further comprising deploying a brake from the UAV.

4. The method of example 3 wherein the brake includes a parachute.

5. The method of any of examples 1-4 wherein the indication is a first indication and wherein the method further comprises:
receiving a second indication of a flight volume; and
in response to the indication, controlling a deployed length of the tether to keep the UAV within the flight volume.

6. The method of example 5, further comprising using data obtained via the UAV to define, at least in part, the flight volume.

7. The method of example 5 wherein tether is a portion of a restraint system, the restraint system further including a winch, and wherein the flight volume has a spatially varying radius from the winch.

8. The method of any of examples 1-7, further comprising coupling the tether to a belay device.

9. The method of any of examples 1-8, further comprising ending flight of the UAV in response to the indication.

10. The method of example 9 wherein ending the flight includes damaging the UAV.

11. The method of any of examples 1-10 wherein applying an acceleration to the UAV includes winching the tether.

12. The method of any of examples 1-11 wherein applying an acceleration to the UAV includes applying an upward acceleration to the tether.

13. The method of any of examples 1-11 wherein applying an acceleration to the UAV includes applying a downward acceleration to the tether.

14. A method for operating a UAV, comprising:
connecting a tether line between the UAV and a motorized winch;
directing the UAV upwardly from a launch site while paying out the winch line from the motorized winch;
directing the UAV along a flight path that includes a failure point, wherein a descent line of the UAV from the failure point intersects a target to be avoided;
while the UAV is at the failure point, receiving an indication of a UAV failure or predicted failure;
in response to the indication, applying an acceleration to the UAV via the tether line in a direction toward the launch site; and
directing the UAV to the ground via the tether, while avoiding contact between the UAV and the target via tension provided by the tether.

15. The method of example 14 wherein directing the UAV to the ground includes cushioning an impact of the UAV with the ground.

16. The method of any of examples 14-15 wherein applying the acceleration to the UAV includes applying the acceleration in a direction aligned along the tether.

17. A method for operating a UAV, comprising:
mapping a flight volume for the UAV with a ground-based scanner, wherein the flight volume excludes a hazard;
connecting a tether line between the UAV and a motorized winch;
directing the UAV upwardly from a launch site while paying out the winch line from the motorized winch;
increasing the flight volume using data collected by the UAV in flight, wherein the increased flight volume excludes the hazard, and wherein the increased flight volume includes a portion inaccessible to the ground-based scanner;
controlling a deployed length of the tether to keep the UAV within the flight volume;
directing the UAV along a flight path that includes a failure point, wherein a descent line of the UAV from the failure point intersects the hazard;
while the UAV is at the failure point, receiving an indication of a UAV failure or predicted failure;
in response to the indication, applying an acceleration to the UAV via the tether line in a direction toward the launch site; and
directing the UAV to the ground via the tether, while avoiding contact between the UAV and the hazard via tension provided by the tether.

18. The method of example 18, further comprising belaying the tether line.

19. An unmanned aerial vehicle (UAV) system, comprising:
a motorized winch;
a UAV;
a tether connectable between the motorized winch and the UAV;
a sensor positioned to detect a failure of the UAV, the sensor being configured to issue a signal corresponding to the failure; and
a controller coupled to the motorized which and programmed with instructions that, when executed:
   in response to the signal issued from the sensor, direct the which to reel in the tether at a rate sufficient to accelerate the UAV toward the winch.

20. The system of example 19 wherein the sensor includes a propulsion system sensor.

21. The system of any of examples 19-20 wherein the sensor includes a navigation system sensor.

22. The system of any of examples 19-21 wherein the sensor is carried by the UAV.

23. The system of any of examples 19-22 wherein the controller is programmed with instructions that, when executed, direct the winch to control a deployed length of the tether to keep the UAV within a target flight volume.

24. The system of example 23 wherein the controller is programmed with instructions that, when executed, receive information corresponding to a boundary of the target flight volume.

25. The system of example 24 wherein the boundary is non-hemispherical.

26. The system of example 24 wherein the information is obtained from the UAV.

27. The system of example 24 wherein the sensor is a first sensor, and wherein the information is obtained from a ground-based second sensor.

From the foregoing, it will be appreciated that some embodiments of the disclosed technology have been described herein for purposes of illustration, but that various modifications may be made without deviating from the disclosed technology. For example, the hazards described above can have attributes other than those specifically described and shown herein. The authorized flight volume may extend up to the hazard in some embodiments, or may be offset from the hazard by a stand-off distance in some embodiments. The UAV 110 can have any number of suitable configurations, including rotary and/or fixed wing configurations. The function of controlling the winch can be performed by a ground-based controller that receives information from an airborne UAV, or directly by the UAV, or by both airborne and ground-based components.

Certain aspects of the technology described in the context of some embodiments may be combined or eliminated in other embodiments. For example, in some embodiments, different entities may perform different elements of the overall process. One entity, for example, may plan or map the flight region, and another may fly the UAV under constraint. The belay device described above can be used in the context of a tether system configured to accelerate the UAV in the event of a UAV failure, or the belay device can be used in conjunction with a simple tether that maintains tension on the UAV but does not actively reel in the UAV. The tether devices described above can be used alone in some embodiments, and in combination with the belay device in other embodiments. Further, while advantages associated with some embodiments of the present technology have been described in the context of those embodiments, other aspects of the disclosed technology may also exhibit such advantages, and not all aspects need necessarily exhibit such advantages to fall within the scope of the present technology. Accordingly, the present disclosure and associated technology can encompass embodiments not expressly shown or described herein. The following examples are also encompassed within the scope of the present technology.

As used herein, the phrase “and/or” as in “A and/or B” refers to A alone, B alone and both A and B. To the extent any materials incorporated herein by reference conflict with the present disclosure, the present disclosure controls. I/We claim:

1. A method for operating a UAV, comprising:
receiving an indication of a UAV failure or predicted failure while the UAV is aloft; and
in response to the indication, applying an acceleration to the UAV via a tether attached to the UAV.

2. The method of claim 1, further comprising:
directing the UAV upwardly from a launch site prior to receiving the indication.

3. The method of claim 1, further comprising deploying a brake from the UAV.

4. The method of claim 3 wherein the brake includes a parachute.

5. The method of claim 1 wherein the indication is a first indication and wherein the method further comprises:
receiving a second indication of a flight volume; and
in response to the indication, controlling a deployed length of the tether to keep the UAV within the flight volume.

6. The method of claim 5, further comprising using data obtained via the UAV to define, at least in part, the flight volume.

7. The method of claim 5 wherein the tether is a portion of a restraint system, the restraint system further including a winch, and wherein the flight volume has a spatially varying radius from the winch.

8. The method of claim 1, further comprising coupling the tether to a belay device.

9. The method of claim 1, further comprising ending flight of the UAV in response to the indication.

10. The method of claim 9 wherein ending the flight includes damaging the UAV.

11. The method of claim 1 wherein applying an acceleration to the UAV includes winching the tether.

12. The method of claim 1 wherein applying an acceleration to the UAV includes applying an upward acceleration to the tether.

13. The method of claim 1 wherein applying an acceleration to the UAV includes applying a downward acceleration to the tether.

14. A method for operating a UAV, comprising:
connecting a tether line between the UAV and a motorized winch;
directing the UAV upwardly from a launch site while paying out the winch line from the motorized which;
directing the UAV along a flight path that includes a failure point, wherein a descent line of the UAV from the failure point intersects a target to be avoided;
while the UAV is at the failure point, receiving an indication of a UAV failure or predicted failure;
in response to the indication, applying an acceleration to the UAV via the tether line in a direction toward the launch site; and
directing the UAV to the ground via the tether, while avoiding contact between the UAV and the target via tension provided by the tether.

15. The method of claim 14 wherein directing the UAV to the ground includes cushioning an impact of the UAV with the ground.

16. The method of claim 14 wherein applying the acceleration to the UAV includes applying the acceleration in a direction aligned along the tether.

17. A method for operating a UAV, comprising:
mapping a flight volume for the UAV with a ground-based scanner, wherein the flight volume excludes a hazard;
connecting a tether line between the UAV and a motorized winch;
directing the UAV upwardly from a launch site while paying out the winch line from the motorized winch;
increasing the flight volume using data collected by the UAV in flight, wherein the increased flight volume excludes the hazard, and wherein the increased flight volume includes a portion inaccessible to the ground-based scanner;
controlling a deployed length of the tether to keep the UAV within the flight volume;
directing the UAV along a flight path that includes a failure point, wherein a descent line of the UAV from the failure point intersects the hazard;
while the UAV is at the failure point, receiving an indication of a UAV failure or predicted failure;
in response to the indication, applying an acceleration to the UAV via the tether line in a direction toward the launch site; and
directing the UAV to the ground via the tether, while avoiding contact between the UAV and the hazard via tension provided by the tether.

18. The method of claim 18, further comprising belaying the tether line.

19. An unmanned aerial vehicle (UAV) system, comprising:
a motorized winch;
a UAV;
a tether connectable between the motorized winch and the UAV;
a sensor positioned to detect a failure of the UAV, the sensor being configured to issue a signal corresponding to the failure; and
a controller coupled to the motorized winch and programmed with instructions that, when executed:
in response to the signal issued from the sensor, direct the winch to reel in the tether at a rate sufficient to accelerate the UAV toward the winch.

20. The system of claim 19 wherein the sensor includes a propulsion system sensor.

21. The system of claim 19 wherein the sensor includes a navigation system sensor.

22. The system of claim 19 wherein the sensor is carried by the UAV.

23. The system of claim 19 wherein the controller is programmed with instructions that, when executed, direct the winch to control a deployed length of the tether to keep the UAV within a target flight volume.

24. The system of claim 23 wherein the controller is programmed with instructions that, when executed, receive information corresponding to a boundary of the target flight volume.

25. The system of claim 24 wherein the boundary is non-hemispherical.

26. The system of claim 24 wherein the information is obtained from the UAV.

27. The system of claim 24 wherein the sensor is a first sensor, and wherein the information is obtained from a ground-based second sensor.
